(19) United States
(12) Patent Application Publication
(10) Pub. No.: US 2005/0072014 A1
(43) Pub. Date: Apr. 7, 2005

(54) Drill bit and stabilizer gauge

(76) Inventor: Eric W. Saunders, Guthrie, OK (US)

Correspondence Address: Richard C. Litman, LITMAN LAW OFFICES, LTD., P.O. Box 15035, Arlington, VA, 22215, US

(21) Appl. No.: 10/912,074

(22) Filed: Aug. 6, 2004

Related U.S. Application Data
(60) Provisional application No. 60/507,960, filed on Oct. 3, 2003.

(51) Int. Cl. G01B 3/10

(52) U.S. Cl. 33/555.4

(57) ABSTRACT

The drill bit and stabilizer gauge is a flexible, elongate strip that is wrapped about the circumference of a drill bit or drill bit stabilizer to measure the diameter. The strip has a rectangular tab at one end with a slot defined therein so that the opposite end of the strip can be inserted through the slot after being wrapped around the drill bit or stabilizer. A zero pointer is stamped on the tab adjacent the slot to ensure accurate measurement. A scale is imprinted on the strip with markings at each interval of π times the dimensional unit and fractions thereof for reading the diameter directly. The gauge is made from spring steel, a thermoplastic material, or other suitable, inextensible, flexible material which has sufficient elasticity, but also sufficient stiffness, that the strip may be bent into a loop retaining a nearly perfect circular form.

### CROSS-REFERENCE TO RELATED APPLICATION

This application claims the benefit of U.S. Provisional Patent Application Ser. No. 60/507,960, filed Oct. 3, 2003.

### BACKGROUND OF THE INVENTION

1. Field of the Invention

The present invention relates generally to measuring devices. More specifically, the invention is a gauge used to measure the diameter of drill bits and drill bit stabilizers for oil drilling rigs, or more generally, any object with a generally cylindrical shape having an irregular surface.

2. Description of the Related Art

Many industrial and commercial applications make use of diameter readings for a wide variety of objects. Oilfield drilling is one such industrial application where measuring the diameter of drill bits and drill stabilizers plays a pivotal role and proves troublesome with conventional gauges. A drill bit used in oil well drilling can be of two basic types: a roller cone bit or a fixed body bit. Although both bits drill circular holes, they are not smoothly cylindrical in nature. A roller cone bit has three rotating cones with carbide teeth spaced 120° apart about a central axis. A solid bit has flutes, either straight or curved, but no moving parts. A drill stabilizer is a fluted cylindrical body placed in the drill string above the drill bit to prevent the drill bit from wobbling during drilling operations, thus stabilizing the bit. The stabilizer is usually equal in diameter to the drill bit or slightly less.

Once the drilling operation commences, the drill bit and stabilizer revolve in unison creating a well bore. This rotation of the drill bit and stabilizer inevitably produces wear on the external diameter (also referred to as “gauge”) of both parts caused by friction created from the contact between the bit/stabilizer components and the well bore wall. When the bit and stabilizer components are retrieved from the well bore, the respective diameters of both components are measured and reported. This data is key to future bit and stabilizer selection as it apprises the user of how much the used bit and stabilizer components have deteriorated in diameter or are under gauge from their previous or original diameters. The conventional method of determining drill bit diameters involves the use of ring gauges, which are rigid steel rings with internal diameters equal to the diameter of a new drill bit. Thus, in an oil drilling operation with multiple drill bit sizes, a separate ring gauge is required for every drill bit size. The amount of wear in the bit is determined by moving the ring against the drill bit and measuring the gap between the drill bit and the ring on the opposite side of the ring.

With stabilizers, a cumbersome right triangular frame with an adjustable base leg is used to determine the diameter of the stabilizer. The triangular frame is placed over the stabilizer with the fluted blades abutting the altitude and hypotenuse legs, while the base leg is gradually moved up the altitude and hypotenuse legs to abut the opposite side of the stabilizer. The diameter is read from a scale on the altitude leg.

Thus, two separate devices are used to measure the diameters of the drill bit and the drill bit stabilizer, and the drill bit gauge must be furnished in multiple sizes to ensure having the proper ring size on hand to match the drill bit being used. It would therefore be desirable to have a single tool capable of measuring the diameter of both a drill bit and a drill bit stabilizer. It would further be desirable to have a tool for measuring the diameter of generally cylindrical objects having irregular surfaces, e.g., fluted surfaces. Numerous gauges, tapes, and other devices for measuring the circumference and/or diameter of objects have been developed, but none show the features of the drill bit and stabilizer gauge of the present invention.

U.S. Pat. No. 1,672,913, issued Jun. 12, 1928 to R. L. Schaap, describes a tape for measuring the diameter of cylinders having two offset ends with scales which form a Vernier scale when wrapped around a cylinder. Schaap does not indicate the material from which the tape is made, but does say that the ends of the embodiment shown in FIGS. 1-4 will fly apart when released.

U.S. Pat. No. 2,262,664, issued Nov. 11, 1941 to G. L. Bresson, describes a tape for measuring the diameter and circumference of round objects. The tape is made from metal, fabric or other suitable material and has an L-shaped member secured to one end with a slot that the opposite end of the tape extends through after being wrapped around the object. The tape has a circumference scale on one side and a scale for reading the diameter directly on the opposite side

U.S. Pat. No. 3,407,507, issued Apr. 10, 1967 to R. L. Brubaker, describes a measuring instrument for measuring the circumference of a cylindrical object or marking diametrically opposed points. The first embodiment of the Brubaker device is made from spring steel, coiled with overlapping ends.

U.S. Pat. No. 6,470,588, issued Oct. 29, 2002 to M. Pilger, discloses a flexible tape made of an essentially inextensible material for measuring a lawn mower reel. A magnet attached to one end permits the flexible tape to be attached to one blade of a lawnmower reel and then coiled around the lawn mower reel in order to measure its diameter. The Pilger invention does not maintain a circular profile, as is obvious from FIG. 2 of the drawings in the Pilger patent, but adapts to the contours of the lawn mower reel, which is not cylindrical in nature. Therefore, the resulting diameter approximation is not optimal.

French Patent No. 2,542,079, published on Sep. 7, 1984, shows a device for measuring diameter essentially comprising a flexible tape with measuring indicia on the front face that is envisioned primarily as a means to measure the diameter of pipes during repair. The tape has a scale with graduations marked in length/π.

International Patent No. WO 00/09968, published Feb. 24, 2000, discloses a measuring tape which can be wrapped around a pipe in spiral fashion with markings on the two ends being aligned. One end of the tape appears to be offset from the other so that the markings on the adjacent wrappings can be aligned.

U.S. Patent Publication No. 2002/0184779, published Dec. 12, 2002, teaches a measuring tape system for measuring the length and girth of a package for mailing. The system includes a tape mounted on a spring-biased reel disposed in a housing. The tape is extended from the housing, wrapped around at least three sides of the package, and temporarily secured in the opposite side of the housing. The system does not appear to be appropriate for measuring the diameter of a cylindrical object, the housing having a flat, straight portion forming part of the loop around the package.

U.S. Pat. No. 650,389, issued May 29, 1900 to C. B. Hatfield, shows a flexible tape for measuring the circumference of a soft or yielding object, such as a foot or other body part of a human. The tape appears to be made of fabric, since it has one end secured by stitching. U.S. Pat. No. 5,406,715, issued Apr. 18, 1995 to Koizumi et al. shows a flexible tape for measuring suits, e.g., chest measurements, having an electronic capacitance measuring device for determining and displaying the measurement.

None of the above inventions and patents, taken either singly or in combination, is seen to describe the instant invention as claimed. Thus a gauge for measuring drill bit and stabilizer diameters solving the aforementioned problems is desired.

### SUMMARY OF THE INVENTION

The drill bit and stabilizer gauge is a flexible elongate strip that is wrapped about the circumference of a drill bit or drill bit stabilizer to measure the diameter. The strip has a rectangular tab at one end with a slot defined therein so that the opposite end of the strip can be inserted through the slot after being wrapped around the drill bit or stabilizer. A zero pointer is stamped on the tab adjacent the slot to ensure accurate measurement. A scale is imprinted on the strip with markings at each interval of π times the dimensional unit and fractions thereof for reading the diameter directly. The gauge is made from spring steel, a thermoplastic material, or other suitable, inextensible, flexible material which has sufficient elasticity, but also sufficient stiffness, that the strip may be bent into a loop retaining a nearly perfect circular form.

In an alternative embodiment tailored for drill collar and drill pipe tool joints, the flexible gauge has the same structure as described above, but also includes a plurality of sets of colored-coded bars strategically printed on the upper surface of the elongate strip member that verify whether or not these tools are within the specifications of the American Petroleum Institute (“API”). The sets of color-coded bars reflect new tool joint diameters on the high end and the API premium cut-off point on the low end, such that a joint diameter is considered premium if the diameter measurement falls within the range of a particular set of color-coded bars. In addition, the flexible gauge can be manufactured in various lengths and thickness to accommodate larger ranges of diameters.

Accordingly, it is a principal object of the invention to provide a drill bit and stabilizer gauge for measuring the diameters of irregular and regular cylindrical surfaces with increased accuracy.

It is another object of the invention to provide a drill bit and stabilizer gauge for measuring the diameters of oilfield drilling bits and drilling stabilizers so that a single gauge can be used for measuring the diameters of both bit and stabilizer.

Another object of the invention is to provide a flexible gauge for determining whether drill collars and drill pipe tool joint diameters are within API specifications.

Still another object of the invention is to provide a drill bit and stabilizer gauge capable of measuring drill bits and stabilizers having a diameter falling within a predetermined range, in order to avoid the necessity of multiple gauges to measure different drill bit diameters.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of the drill bit and stabilizer gauge according to the present invention.

FIG. 2 is an environmental perspective view showing the drill bit and stabilizer gauge according to the present invention wrapped around the head of a roller drill bit in order to measure the diameter of the drill bit.

FIG. 3 is a perspective view of a drill bit and stabilizer gauge according to the present invention adapted for measuring the diameter of drill collars and drill pipe tool joints.

Similar reference characters denote corresponding features consistently throughout the attached drawings.

### DETAILED DESCRIPTION OF THE PREFERRED EMBODIMENTS

The present invention is a drill bit and stabilizer gauge, designated generally as 10 in the drawings. The gauge 10 of the present invention is generally designed for use in determining the diameters of drill bits, drill bit stabilizers, and other cylindrical objects having irregular surfaces, although the gauge 10 may also be used for measuring the diameter of cylindrical objects having smooth surfaces.

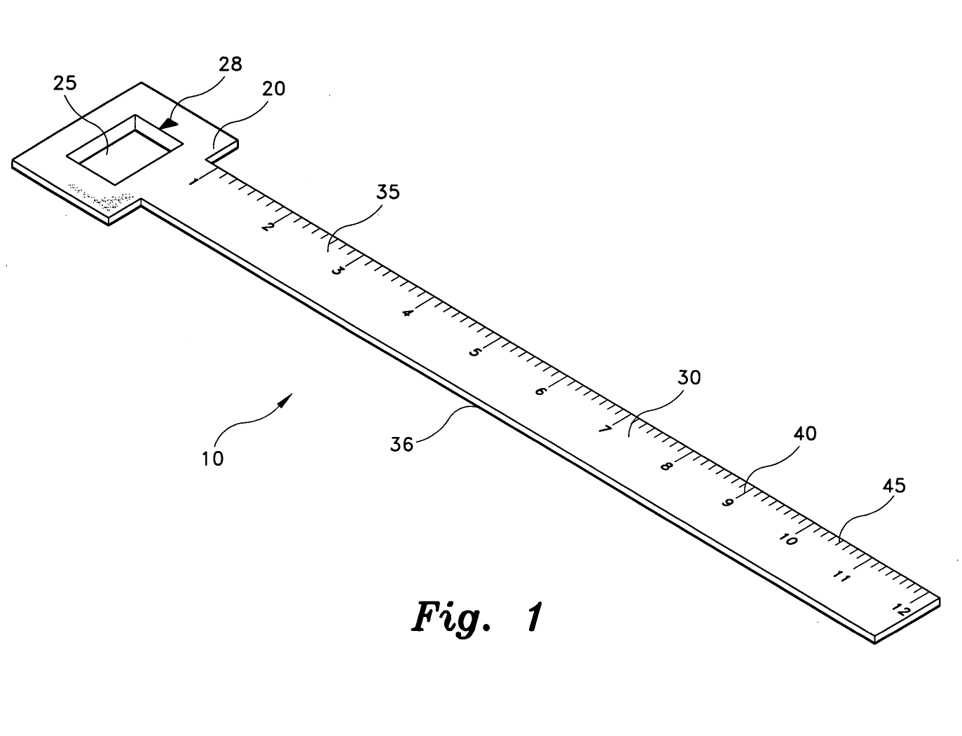

Referring to FIG. 1, the gauge 10 is an elongate strip 30 having a substantially rectangular tab 20 on one end. The tab 20 has a substantially rectangular slot 25 defined in the center of the tab. An arrowhead defines a zero marker 28 imprinted on the upper surface 35 of the tab 20 located at, and pointed towards, the midpoint of the slot 25 on at least one side of the tab 20. The elongate strip 30 extends from the base of the tab 20 to a length dictated by the range of diameters to be measured. The elongate strip member 30 is characterized by an upper surface 35 and a lower surface 36.

30 The upper surface 35 of the elongate strip member 30 has a plurality of measuring indicia 40,45 comprising a scale printed thereon along one edge. The scale is characterized by major markings 40 and minor markings 45 mathematically scaled to provide a diameter reading converted from a circumferential measurement and adjusted to compensate for the thickness of the flexible gauge. The major markings 40 represent a convenient dimension separated by a function of π. Thus, on an inch scale, the major markings 40 are separated by about 3.1416 inches with the minor markings accordingly spaced between the major markings at fractions of π times the unit dimension. Alternatively, measuring indicia can be included that provide the circumference measurement in conjunction with measuring the diameter.

The gauge 10 is constructed from a material which is essentially inextensible, but having sufficiently elastic properties that allow the flexible gauge 10 to be wrapped around a cylindrical object, retaining enough stiffness to form a nearly perfect circle, thereby providing a more accurate measurement of the diameter of irregular cylindrical objects, such as oilfield drilling tools. Materials with the requisite properties include, but are not limited to, various thermoplastic materials, such as polycarbonate, and spring steel. In the case of thermoplastic materials, the gauge may be made of transparent material.

Depending on the material used, the diameter of the cylinder to be measured, and the length of the strip 30, the thickness of the flexible gauge 10 will vary. Representative dimensions for a gauge 10 made from polycarbonate are as follows. The strip 30 is preferably about one inch wide. The tab 20 may be about two inches wide by an inch and one-half long. The slot 25 is slightly wider than the strip 30 in order to allow the free end of the strip 30 to pass through the slot 25, measuring, e.g., about 1.06 inches wide by about three-quarter inches long. A gauge 10 adapted to measure the diameter of a drill bit or stabilizer between three and nine inches may have a total length (including the strip 30 and tab 20) of about thirty inches and a thickness of about twenty mils (thousandths of an inch). A gauge 10 adapted to measure the diameter of a drill bit or stabilizer between eight and eighteen inches may have a total length (including the strip 30 and tab 20) of about fifty-nine inches and a thickness of about thirty mils. A gauge 10 adapted to measure the diameter of a drill bit or stabilizer between fourteen and twenty-seven inches may have a total length (including the strip 30 and tab 20) of about eighty-five inches and a thickness of about forty mils.

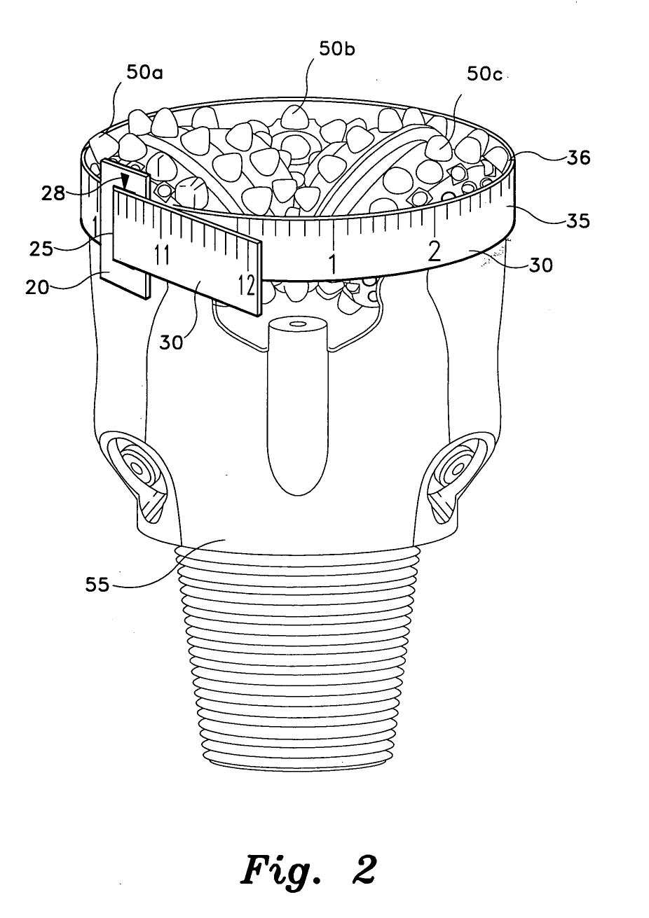

Referring to FIG. 2, the gauge 10 is shown measuring the diameter of a roller cone drill bit 55. The drill bit 55 drills a circular hole, but the head of the drill bit is not perfectly cylindrical. The roller cone drill bit 55 features three rotating, toothed cones 50a,50b,50c spaced apart about a central axis, thus allowing the drill bit 55 to penetrate a medium to create a circular hole. As the friction created from the drilling operation wears the external diameter of the roller cones 50a,50b,50c, it becomes necessary to determine the diameter of the roller cones 50a,50b,50c to compute the degree to which the hole has been drilled under gauge.

In order to obtain a diameter reading, the gauge 10 is first manipulated into a circular loop large enough to encompass the roller cones 50a,50b,50c. Next, the free end of the elongate strip member 30 is received through the slot 25 in the tab 20 until the lower surface 36 snugly engages the circumference of the roller cones 50a,50b,50c. The zero marker 28 printed on the upper surface 35 of the tab 20 at the midpoint of the slot 25 points to the diameter reading on the scale 40, 45.

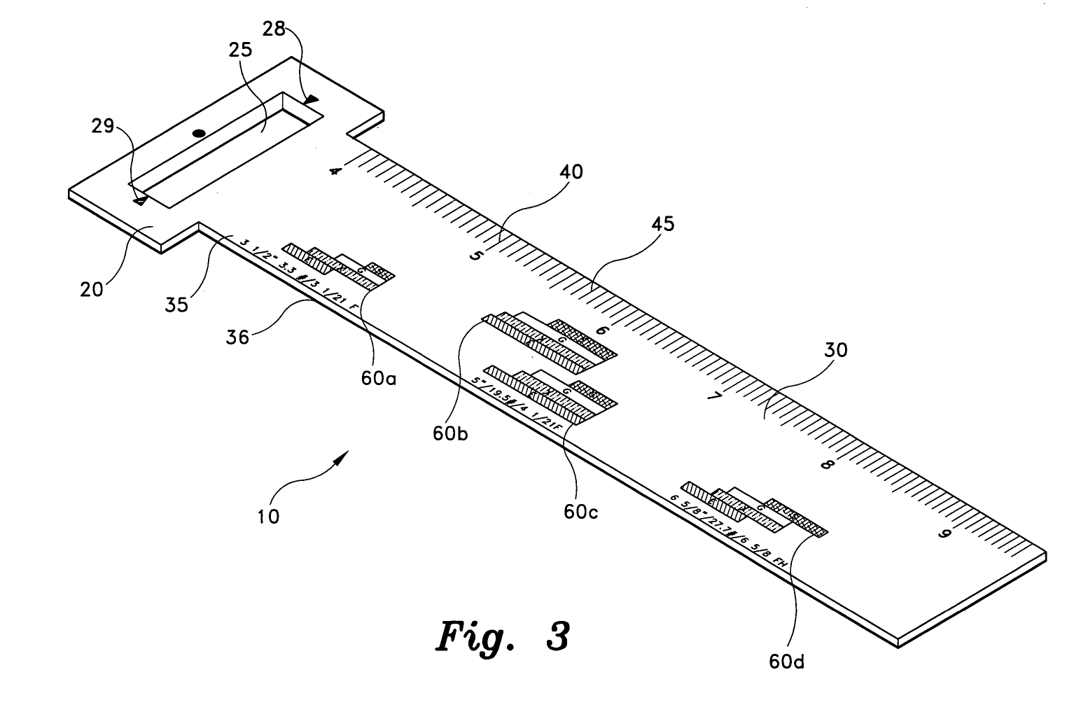

Referring to FIG. 3, in an alternative embodiment the drill bit and stabilizer gauge 10 is shown adapted for measuring the diameter of oilfield drill pipe tool joints. Drill pipe tool joints are smooth cylindrical surfaces. The gauge 10 is essentially the same as that shown in FIGS. 1 and 2, except that the gauge 10 also includes a plurality of colored-coded sets of bars 60a,60b,60c,60d strategically printed on the upper surface 35. The bars 60a,60b,60c, and 60d show a scale ranging from the diameter of a new drill pipe tool joint to the minimum acceptable premium diameter under American Petroleum Institute (API) standards. Each color-coded set of bars 60a,60b,60c,60d consists of four bars, each a different color, staggered with respect to one another. Each color represents a specific tensile yield strength for a drill pipe tool joint being measured. Each color-coded set of bars 60a,60b,60c,60d reflects new drill pipe tool joint diameters on the high end and the API premium cut-off point on the low end. A drill pipe tool joint diameter of a particular tensile yield strength is considered premium if the diameter measurement falls within the specific color-coded bar 60a,60b,60c,60d for that particular tensile yield strength, as indicated by the arrowhead indicator 29 printed on the upper surface 35 located at and pointing towards the midpoint of the slot 25, once the lower surface 36 of the gauge 10 is snugly engaged to the circumference of the drill pipe tool joint as the base of the elongate strip member 30 passes through the slot 25.

Each color-coded set of bars 60a,60b,60c,60d corresponds to the API specifications for a different specified diameter. For example, the color-coded set of bars 60d near the base of the elongate strip member 30 is specific to a tool with an original diameter of 6⅝″. In this embodiment, the elongate strip member 30 is widened to accommodate the color-coded sets of bars 60a,60b,60c,60d on the upper surface 35 while leaving the diameter measuring indicia 40,45 and diameter arrowhead indicator 28 undisturbed. This embodiment can be adapted to provide specification ranges tailored to several different types of applications.

The gauge 10 can be manufactured in various lengths and thickness to accommodate larger ranges of diameters.

It is to be understood that the present invention is not limited to the embodiments described above, but encompasses any and all embodiments within the scope of the following claims.

1. A drill bit and stabilizer gauge, comprising:
a substantially rectangular tab having a slot defined therein, the slot having a width, an upper surface, and a lower surface;
a thin, flat, elongate, flexible strip integral with and extending from the tab and having a free end, an upper surface, and a lower surface, the strip having a width slightly smaller than the width of the slot, the strip being sufficiently stiff to maintain a circular form when wrapped into a loop with the free end inserted through the slot;
a zero marker imprinted on the upper surface of the tab and aligned with the slot; and
a scale imprinted on the upper surface of the strip and extending from the zero marker, the scale having major markings corresponding to lengths of pi times a dimensional unit;
whereby the gauge is adapted for being wrapped around drill bits and drill bit stabilizers in order to measure diameter directly on the scale.

2. The drill bit and stabilizer gauge according to claim 1, further comprising a plurality of color coded bars imprinted on the strip reflecting ranges of premium diameter measurements for drill pipe tool joints for joints of specified nominal diameters.

3. The drill bit and stabilizer gauge according to claim 1, wherein the drill bit and stabilizer gauge is made from polycarbonate.

4. The drill bit and stabilizer gauge according to claim 1, wherein the drill bit and stabilizer gauge is made from spring steel.

5. The drill bit and stabilizer gauge according to claim 1, wherein the drill bit and stabilizer gauge is made from an elastic, inextensible, transparent material.

6. The drill bit and stabilizer gauge according to claim 1, wherein said strip has a first edge and an opposing second edge, said zero marker and said scale being disposed adjacent the first edge.

7. The drill bit and stabilizer gauge according to claim 6, further comprising:
an arrowhead indicator imprinted on the upper surface of the tab and aligned with the slot adjacent the second edge; and
at least one set of elongate color-coded bars aligned with the scale and disposed adjacent the second edge, the set corresponding to a drill pipe tool joint of a selected nominal diameter, each of the bars corresponding to a selected drill pipe tool joint tensile strength, each of the bars having a length corresponding to a minimum acceptable diameter to the nominal diameter;
whereby the gauge may be wrapped around a drill pipe tool joint, the actual diameter being determined by alignment of the zero marker with the scale disposed adjacent the first edge, and the drill pipe tool joint being within acceptable limits when the arrowhead indicator is aligned with the color-coded bar corresponding to the tensile strength of the drill pipe tool joint.
